(19) United States
(12) Patent Application Publication
(10) Pub. No.: US 2011/0035270 A1
(43) Pub. Date: Feb. 10, 2011

(54) Network Advertisement Transmission Device and Method

(75) Inventors: Hisashi Matsunaga, Tokyo (JP); Hideaki Haruta, Tokyo (JP); Hiroki Noda, Tokyo (JP)

Correspondence Address: SAMPSON & ASSOCIATES, P.C., 50 CONGRESS STREET, BOSTON, MA, 02109, US

(73) Assignee: Intex Recreation Corp, Long Beach, CA (US)

(21) Appl. No.: 12/521,270

(22) PCT Filed: Dec. 27, 2007
(86) PCT No.: PCT/JP2007/001488

§ 371 Date: Jun. 25, 2009

(30) Foreign Application Priority Data
Dec. 27, 2006 (JP) 2006-353446

(51) Int. Cl. G06Q 30/00

(52) U.S. Cl. 705/14.41; 705/14.4

(57) ABSTRACT

A technique of integrating advertisements through broadcasting with that through a network out of advertisement media and particularly a technique of producing high advertisement effectiveness by automatically synchronizing advertisement timing is provided. A network advertisement transmitting method for transmitting advertisement data outputted at the user terminal device, comprising in advance a broadcast information database 121 storing broadcast information relating to at least broadcast contents and broadcast time of advertisements delivered on broadcast media such as TV in storage means, an advertisement condition database 122 storing corresponding advertisement data and transmission conditions thereof in storage means according to the broadcast contents and the transmission conditions including at least a condition relationship between the advertisement information and a current time, and an advertisement transmitting portion 105 transmits the advertisement data to the user terminal device through the network if the current time obtained from clocking portion (101) satisfies the transmission condition.

### TECHNICAL FIELD

The present invention relates to a network advertisement transmission device and method connected to a user terminal device through a network and capable of transmitting advertisement data to be outputted in the user terminal device and particularly to a technique relating to timing for transmitting the advertisement data.

### BACKGROUND ART

Technological innovation in the broadcasting communication field has been remarkable in recent years, and modes of television viewing in general households have been largely changed due to a wide spread of the Internet and switching to digital TV broadcasting. Particularly, provision of an access function to the Internet in a digital TV set and offering of products in which the digital TV set is integrated with a personal computer or video game have increased opportunities for users to use TV and the Internet at the same time.

When a commercial on a product is on TV, for example, a user who gets interested in the product searches its information on the Internet in many cases, and it is known that after the commercial, access to a web site of the product on the Internet is increased. Recently, access to a URL (Uniform Resource Locator) is promoted for users by presenting a specific URL during the commercial.

A trial to effectively integrate a broadcasting media including TV and a network including the Internet has been made. On the other hand, users spend a long time in using the Internet, with which the advertisement market on the Internet has rapidly expanded, and advertisers have positioned the Internet as one of important advertising media.

Selection of the advertising medium in general is designed such that the most effective advertising strategy can be used by combining various media as appropriate through an advertising agency. The advertising agency is demanded to make a proposal based on sophisticated information collection and know-how on how to combine which media at what ratio, how to distribute the advertising budget and the like in the Internet in addition to TV, radio, newspaper, and magazine on the basis of researches on various viewers and experiences.

Such an advertising strategy has been formulated on the basis of a system uniquely owned by the advertising agency, the experiences and hunches, and synergistic utilization of advertising media has been only made artificially in measures such as presentation of URL in the commercials as described above or notification of a period of newspaper advertisements in the commercial, for example.

However, by integrating both the advertisements on a more real-time basis in the coexistence of TV and the Internet as mentioned above, higher advertising effectiveness can be expected. Such a combination of media is also suggested in Non-Patent Document 1, for example.

Such a technique is relatively easy in a single Internet terminal and a single digital television, and some proposals have been already made. In the technique disclosed in Patent Document 1, for example, a system for providing information relating to contents broadcast in a program/CM desired by audiences by the same means in the program/CM in digital broadcasting is proposed. This technique discloses provision of commercial transaction means group including content information searching means for searching contents information recorded in a database relating to the program/CM contents from programs/CM being received and goods transaction means for making goods transaction by searching goods information recorded in the database relating to mail-order sale associated with the contents information obtained by the contents information searching means and homepage connecting means for connecting to a homepage with a homepage address set in the contents information.

Patent Document 2 pays attention to the fact that there are many banners not relating to the searched TV program in a search using EPG in digital broadcast, which does not attract interest of users, and discloses a technique in which needs of an advertising client matches needs of a user. For that purpose, an information acquisition method is provided such as an advertisement using the Internet in which a user connects to a relay server through the Internet from an Internet-ready terminal machine owned by the user, searches a program using an EPG function that enables reaching the information page of the desired TV program using a search function toward a deep layer from a top screen through the relay server, and pastes an advertisement such as a banner advertisement relating to the program in a display screen of the searched program information so that the information in the deep layer can be obtained sequentially by clicking the advertisement information.

Presentation of advertisements on Internet sites are known, and various systems and methods are provided, and Patent Document 3, for example, discloses a technique relating to transition to a WWW server of an advertiser from a banner advertisement.

### Citation List

Non-Patent Document 1: AD-Topic <Internet Advertisement>“System Reinforcement by Advertizing Companies in Reactivated Business—Combination with Mass Media as Key—” Business and Advertisement, April 2005

### Patent Document 1: Japanese Patent Laid-Open No. 2002-290947

### Patent Document 2: Japanese Patent Laid-Open No. 2002-245330

### Patent Document 3: Japanese Patent Laid-Open No. 2003-141410

### SUMMARY OF INVENTION

The present invention was made in view of the above problems of the prior art and has an object to provide a technique to integrate advertisement through broadcasting with that through a network out of advertisement media and particularly a technique of producing high advertisement effectiveness by automatically synchronizing the advertisement timing.

In order to solve the above problems, the present invention uses the following means. First, the present invention provides a network advertisement transmitting device (hereinafter referred to as the device) connected to a user terminal device through a network and capable of transmitting advertisement data outputted at the user terminal device. The device is provided with a broadcast information database storing broadcast information relating to at least broadcast contents and broadcast time of broadcast transmitted on a wired or wireless broadcast medium intended to be directly received by the public in storage means and an advertisement condition database storing corresponding advertisement data and transmission conditions thereof in the storage means according to the broadcast contents. The transmission conditions include at least a condition relationship between the advertisement information and a current time. Also, advertisement transmitting means is provided for transmitting the advertisement data from the broadcast condition database to the user terminal device through the network if the current time obtained from clocking means satisfies the transmission condition.

In the network advertisement transmitting device, such a case may be included that the broadcast programs are broadcast shows of news, sports, performance, entertainment, discussion and the like.

If the broadcast program is a broadcast show, goods information extracting means for extracting information on a goods relating to goods or service from the broadcast contents of the broadcast show may be provided so that the extracted information is made as advertisement contents, the broadcast information at that time as advertisement information, and the broadcast information database at that time as an advertisement information database.

A case in which the broadcast program is an advertisement is included, and in that case, the broadcast contents may be advertisement contents, the broadcast information may be advertisement information, and the broadcast information database may be the advertisement information database.

The device may be provided with advertisement frequency estimating means for estimating an advertisement frequency that the advertisement information reaches apart of or the whole of the public on the basis of the information including at least any one of the broadcast number of times, broadcast time, and broadcast audience rate of the advertisement information, and the advertisement condition database may be provided with a transmission condition table defining a transmission mode of the advertisement data corresponding to the advertisement frequency for each type of the advertisement contents. The advertisement transmitting means is characterized to transmit the advertisement data according to the advertisement frequency by the advertisement frequency estimating means according to the transmission conditions.

The device may be provided with advertisement reach estimating means for estimating an advertisement reach that the advertisement information reaches apart of or the whole of the public on the basis of the information including at least any one of the broadcast number of times, broadcast time, and broadcast audience rate of the advertisement information, and the advertisement condition database may be provided with a transmission condition table defining a transmission mode of the advertisement data corresponding to the advertisement reach for each type of the advertisement contents. The advertisement transmitting means is characterized to transmit the advertisement data according to the advertisement reach by the advertisement reach estimating means according to the transmission conditions.

The device may be provided with terminal installed position information acquisition means for acquiring installed position information of the user terminal, and the transmission conditions may include a condition according to the installed position of the user terminal.

The broadcast media may be TV broadcast or radio broadcast. The broadcast media may be at least either one of image or video delivery or sound delivery using a network communication path.

The advertisement data is characterized to be at least any one of text data, image data, video data or sound data constituting video advertisement, banner advertisement or text advertisement.

The network is characterized to be the Internet. The network may be a cellular phone line or PHS phone line, and the user terminal device may be its phone terminal.

The device may be a search site server provided with a search engine of the Internet, and the advertisement data may be presented on the search site screen. The device may be a goods-sales site server selling goods on the Internet, and the advertisement data may be presented on the goods-sales site screen.

The present invention may provide a network advertisement transmitting method of a computer in the network advertisement transmitting device as follows. That is, the network advertisement transmitting method is provided in which a broadcast information database storing broadcast information relating to at least broadcast contents and broadcast time out of broadcast sent on a wired or wireless broadcast medium intended to be directly received by the public in storage means and an advertisement condition database storing corresponding advertisement data and transmission conditions thereof in the storage means according to the broadcast contents are provided in advance, the transmission conditions include at least a condition relationship between the broadcast information and the current time, and an advertisement transmission step is provided in which the advertisement transmitting means of a computer transmits the advertisement data from the advertisement condition database to the user terminal device through the network if the current time obtained from the clocking means satisfies the transmission conditions.

Such a case may be included that the broadcast programs are broadcast shows of news, sports, performance, entertainment, discussion and the like. If the broadcast program is a broadcast show, before the advertisement transmission step, a goods information extracting step in which goods information extracting means of a computer extracts information on goods relating to an article or service from the broadcast contents of the broadcast show may be provided and the extracted information may be made advertisement contents, the broadcast information at that time as advertisement information, and the broadcast information database at that time as an advertisement information database.

A case in which the broadcast program is an advertisement is included, and in that case, the broadcast contents may be advertisement contents, the broadcast information may be advertisement information, and the broadcast information database may be the advertisement information database.

In the network advertisement transmitting method, it may be so configured that the transmission condition table defining the transmission modes of the advertisement data corresponding to an advertisement reach for each type of the advertisement contents is provided in advance in the advertisement condition database, an advertisement reach estimating step in which the advertisement reach estimating means of a computer estimates an advertisement reach the advertisement information reaches apart of or the whole of the public on the basis of information including at least any one of the broadcast number of times, broadcast time, and broadcast audience rate of the advertisement information is provided before the advertisement transmission step, and in the advertisement transmission step, the advertisement transmitting means of a computer transmits the advertisement data according to the advertisement reach by the advertisement reach estimating means according to the transmission conditions.

In the network advertisement transmitting method, it may be so configured that a terminal installed position information acquisition step in which the terminal installed position information acquisition means of a computer acquires the installed position information of the user terminal is provided before the advertisement transmission step, and the transmission conditions include a condition according to the installed position of the user terminal.

The broadcast media is characterized to be TV broadcast or radio broadcast. The broadcast media may be at least either one of image or video delivery or sound delivery using a network communication path.

The advertisement data is characterized to be at least any one of text data, image data, video data or sound data constituting video advertisement, banner advertisement or text advertisement.

The network is characterized to be the Internet. The network may be a cellular phone line or PHS phone line, and the user terminal device may be its phone terminal.

It may be so configured that the network advertisement transmitting method according to the present invention is used in a search site server provided with a search engine of the Internet, and the image and video advertisement data is presented on the search site screen. It may be so configured that the network advertisement transmitting method according to the present invention is used in a goods-sales site server selling goods on the Internet, and the advertisement data is presented on the goods-sales site screen.

Since the present invention is constituted as mentioned above, the following working effects are exerted. That is, in the present invention, broadcast contents transmitted at the current time can be known by referring to the broadcast information database, and the advertisement data can be transmitted according to the transmission conditions defined according to the broadcast contents.

If the broadcast program is a show, the advertisement can be transmitted according to the contents of the show. If, for example, news relating to a hybrid car is to be broadcast, the advertisement data on the hybrid car can be transmitted.

Also, contents of articles or goods relating to a show can be extracted from the contents of the show by the goods information extracting means. If a special program regarding a state-of-art engine is to be broadcast, for example, goods information on goods relating to the engine such as automobiles and motorcycles, service relating to engine tune-up and the like is extracted, and the advertisement according to that can be transmitted.

Therefore, since the advertisement can be transmitted on the network according to a show or advertisement in a broadcast medium, if a user who took interest in the advertisement contents on the broadcast medium makes a search about in on the network, chances of contact with the advertisement is particularly increased, which can improve advertisement effectiveness.

For example, it is known from the advertisement information database that CM of an advertisement is placed at a certain time on TV, and by defining in the transmission condition transmission during a period from 1 minute to 15 minutes after the CM is transmitted, the advertisement transmitting means can present a banner advertisement at apart of a web page in that time zone.

If a user takes interest through the CM on TV and makes an access to a web page such as a search site and a goods sales site, the banner advertisement is displayed just at the timing, and the user can easily access the information. Naturally, the advertiser can obtain high advertisement effectiveness along with the TV CM, and an advertisement amount can be suppressed during time when there is less access from users, which contributes to reduction in advertising cost and also to optimization.

Particularly, since a large amount of information is present on the network, even if a user takes interest in specific goods in an advertisement, the user might come into contact with another piece of information, and there was a worry that the user's interest might move to competitive goods. However, according to the method of the present invention, since the user can be reliably led to the information of the applicable goods, it becomes possible to exclusively contain the user, which exerts a synergetic effect.

### DESCRIPTION OF EMBODIMENTS

An embodiment of the present invention will be described below referring to the attached drawings. FIG. 1A is an entire configuration diagram of a system (1) using an advertisement transmitting device (this device) (10) according to the present invention. The advertisement transmitting device (10) is connected to the Internet (2), and a plurality of user terminal devices (3) (4) to which the advertisement is transmitted are connected to the Internet. A configuration of this network is as known.

The network of the present invention is not limited to the Internet, but arbitrary networks including a cable network in a limited area, a cellular phone network, a PHS network and the like can be used. The user terminal device takes a corresponding terminal configuration according to the type of the network. For example, if the network is the cellular phone network, the user terminal device is a cellular phone terminal, and a configuration to connect the cellular phone terminal to a unique network (“i-mode” (registered trademark) service provided by NTT DoCoMo Inc., for example) is known.

FIG. 1B shows a system configuration of TV broadcast as an example of the broadcast media of the present invention. As shown in the figure, a TV signal (6) is transmitted by radio from a TV broadcast station (5), and a TV set (7) installed in a household receives it and outputs video (including sound. The same applies to the following). In the TV broadcasting, transition from analog broadcasting to digital broadcasting has progressed recently, and a transmitted TV signal has changed from an analog signal to a digital signal. In the case of the digital signal, various types of attached information is transmitted with video, and electronic program tables or attached advertisement information, weather information, traffic information and the like are also transmitted, for example.

As the broadcast media according to the present invention, media called mass media in general to be transmitted to the public in a wide range is suitable, and its typical example is TV broadcast and radio broadcast. The public directly receives it through TV sets or radio sets. Also, wired broadcast media such as cable TV, wired music broadcast and the like and broadcast media for delivering programs through the Internet can be used as the broadcast media.

The broadcast through the Internet is divided into the one for delivering programs at once and the other for delivering programs on demand according to an instruction from a user, and either of them are applicable. That is, since advertisement broadcast time contained in the advertisement information used in the present invention is a concept including not only the units of second, minute and hour but also certain periods of time such as the units of day, week and month, there is no problem even if the advertisement time gains/delays by the unit of second, minute or hour in accordance with the program time as long as the advertisement is sent during this period. In the Internet broadcast, delivery of image (including both moving images and still images) and sound is possible in addition to video delivery.

FIG. 2 shows a configuration diagram of the device (10). The device (10) is configured the most easily by a known personal computer and the following description will be made based on that. But an exclusive hardware may be used or the device may be incorporated as a part of a server device as will be described later.

In the device (10), as is known, hardware such as a CPU (100) for governing calculation processing, information processing and the like, a network adapter (110) for connection with the Internet (2), a hard disk (120) for storing various types of information such as a database, a monitor (130) for screen display, a keyboard (140) for receiving inputs from a user and the like as well as a memory (150) operating with the processing in the CPU (100) are provided.

The hard disk (120) is provided with an advertisement information database (hereinafter referred to as advertisement information DB) (121) and an advertisement condition database (hereinafter referred to as advertisement condition DB) (122). Contents of each database will be described later.

### First Embodiment

In the first embodiment of the present invention, a clocking portion (101) for clocking a current time by an oscillator built in the CPU (100) and an advertisement transmission portion (105) are provided. This is the simplest mode of the present invention. FIG. 3 shows a processing flowchart of the first embodiment. That is, from advertisement information according to TV commercials in the advertisement information DB (121), a transmission condition in the advertisement condition DB (122), and a current time obtained at the clocking portion (101), the advertisement transmission portion (105) determines if the transmission condition is satisfied or not (S10), and if satisfied, the advertisement data is transmitted (S11) (advertisement transmission step). The advertisement information in the present invention refers to advertisement through the broadcast media, and the advertisement data refers to the advertisement in the network. In order to facilitate discrimination below, the advertisement information might be referred to as CM information and the advertisement contents as CM contents.

The advertisement transmission step will be described below in detail. In the present invention, the CM information according to the CM contents and broadcast time is stored in advance in the advertisement information DB (121), which is an information table as shown in Table 1 as an example.

TABLE 1
CM information

| | | Broadcast | | |
|---|---|---|---|---|
| Advertiser | CM contents | station | Start time | End time |
| A company | Product A1 | X TV | Mon. 15:00:15 | Mon. 15:00:30 |
| A company | Product A2 | X TV | Mon. 15:30:30 | Mon. 15:30:45 |
| B company | Product B1 | TV Y | Mon. 14:55:00 | Mon. 14:55:30 |
| C company | Product C1 | X TV | Mon. 15:15:00 | Mon. 15:15:15 |
| C company | Product C2 | Z | Tue. 16:00:30 | Tue. 16:00:45 |
| | | broadcast | | |

That is, advertisers, CM contents (creative), broadcast station names which broadcast program, CM start time, and CM end time are recorded.

Subsequently, in the advertisement condition DB (122), the advertisement data and its transmission conditions are stored in advance, which is an information table as shown in Table 2 as an example.

TABLE 2
Transmission condition

| | Advertisement | Advertisement | Transmission | Transmission | Transmission |
|---|---|---|---|---|---|
| 1 | contents | data | start timing | end timing | position |
| 2 | Product A1 | Banner data 1 | 30 seconds | 15 minutes | Banner |
| | | | after | after | advertisement |
| | | | advertisement | advertisement | region 1 |
| | | | end | end | |
| 3 | Product A1 | Banner data 2 | 15 minutes | 5 hours after | Banner |
| | | | after | advertisement | advertisement |
| | | | advertisement | end | region 2 |
| | | | end | | |
| 4 | Product A2 | Banner data 3 | 30 seconds | 15 minutes | Banner |
| | | | after | after | advertisement |
| | | | advertisement | advertisement | region 1 |
| | | | end | end | |
| 5 | Product A2 | Text data 1 | 15 minutes | 3 hours after | Text |
| | | | after | advertisement | advertisement |
| | | | advertisement | end | region 1 |
| | | | end | | |
| 6 | Product A2 | Streaming | At the same | Data length | Popup window |
| | | data 1 | time as | | |
| | | | advertisement | | |
| | | | end | | |

The contents in Table 2 will be described in detail. In the transmission condition, the CM contents, advertisement data, transmission start timing of the advertisement, the end timing of the same, and the display position (transmission position) of the advertisement on the web page (site) are defined. FIG. 11 shows an example of a screen display (90) displayed using a web browser in the user terminal device.

For example, with regard to the product A1 on the second row, it is defined that the banner data 1 accumulated in the advertisement condition DB is displayed in the banner advertisement region 1 (900) on the site from 30 seconds after the CM ends to 15 minutes after. Combined with the information in Table 1, the data of the banner data 1 is displayed from 15:01:00 to 15:15:30 on Mondays.

Then, according to the transmission condition on the third row, the banner data 2 is displayed in the banner advertisement region 2 (901) from 15 minutes after the advertisement ends to 5 hours after. An advertising rate on the Internet web page is determined by display position, display size, display time, display frequency and the like in general, and the banner advertisement region 1 with the highest advertisement effectiveness is used immediately after the CM ends and then, the display is made in the banner advertisement region 2 for 5 hours. By defining the transmission condition as above, the advertisement mode on the web page can be changed in a complicated manner in collaboration with delivery of the CM.

Also, in the transmission condition on the fifth row, it is defined that the text advertisement for the product A2 is placed in the text advertisement region 1 (902). In the transmission condition on the sixth row, it is defined that video by the streaming data 1 is displayed on the popup window (new exclusive window is opened) (903). In this way, advertisement data in various data formats can be freely defined for the transmission conditions of the present invention.

The advertisement data itself does not have to be stored in the advertisement condition DB (122) but it may be so configured that the image files, video files, text files, sound files and the like are stored separately and file names, directory names and the like indicating the storage locations are stored instead. Also, it may be so configured that the advertisement data itself is stored in another server device on the network such as a server device of the advertiser, for example, and its URL is stored as information of the advertisement data.

From a clocking result at the clocking portion (101) together with the advertisement information and the transmission conditions as above, the advertisement transmission portion (105) transmits the advertisement data to the user terminal device. The advertisement data transmitted from the advertisement transmission portion (105) at that time is transmitted from the network adapter (110) to the user terminal device under control of a communication portion (104). The advertisement data is outputted from a screen, a speaker and the like in the terminal.

In the above transmission conditions, the condition is shown as an example that transmission is made immediately after the end time of the CM or after a certain period of time has elapsed with the end time as a reference, but before or after the CM or the length of the time zone is arbitrary. For example, by increasing exposure of the advertisement on the Internet from 30 minutes before the CM and by giving the CM by each TV station when the interest of users making accesses is heightened, recognition by the users can be made certain.

Moreover, supposing that the broadcast media is broadcast on the Internet and the delivery period of the program is from Oct. 1 to Oct. 14, 2006. Then, the transmission conditions for a longer period may be defined such that the advertisement data is synchronized with that and the banner advertisement is displayed in the banner advertisement region 1 (900) at the transmission start timing from Oct. 1 to 14, 2006 and then, the banner advertisement is displayed in the banner advertisement region 2 (901) from October 15 to 22.

There has been a case in which the advertisement by broadcast media such as TV and the advertisement on the network are placed manually at the same timing. According to the present invention, while transmission of the advertisement is automatically grasped by the advertisement information DB (121), appropriate advertisement data can be transmitted at appropriate timing according to complicated conditions defined by the transmission conditions. As a result, when users who took interest through the broadcast media access the Internet, the advertisement is displayed at a position with high visibility, and high advertisement effectiveness can be obtained. Moreover, by changing the advertisement position with time, the screen mode can bring about changes, and contribution can be made to reduction of advertising costs.

### Second Embodiment

A basic configuration of the present invention is as above, and a configuration in which a CPU (100) shown in FIG. 2 is provided with an advertisement frequency estimation portion (102) and its estimation result is used for determination of the transmission condition will be described in detail as a second embodiment.

First, the advertisement frequency will be described using FIG. 7. In advertising agencies, the advertisement frequency (frequency) is used as a parameter for measuring effectiveness of the advertisement. The advertisements may be intended for the public receiving the broadcast or may be intended for specific targets such as apart of the public, age, sex, occupation, position in the household (father, grandmother, children, grand-children and the like), social status and the like. An index indicating how many times the advertisement contents (creative) reach the entire public or a part thereof is the frequency.

The frequency can be searched using various methods, and an average frequency can be known by conducting a questionnaire such that “How many times have you seen the CM of the car B by the A company?” in an audience research. In the present invention, such research results may be stored in the hard disk (120) and used as they are.

However, a configuration in which the advertisement frequency estimation portion (102) executes and processes an advertisement frequency estimation step (S20) according to a processing flowchart shown in FIG. 4 will be described here. At the advertisement frequency estimation step (S20), information on the number of broadcasting times or broadcast time in the advertisement information DB (121) and the information on the audience rate researched separately are used. For example, as shown in FIG. 7, supposing that a man in the thirties does not view a program at 10 o'clock on Friday but views one at 11 o'clock and 12 o'clock, and the number of CM placement times of the car B by the A company is 0 times at 10 o'clock and 11 o'clock on Friday and 1 time at 12 o'clock, it means that the man views the CM once on Friday. By calculating similarly, the frequency of the CM by this man in this week results in 7.

Here, the example of a man belonging to a specific audience for a single channel in a limited time zone was exemplified, but since data according to specific audiences on information of the audience rates is offered by survey companies, the audience rate of a man in the thirties for a specific channel by time zone, for example, can be obtained. For example, if the audience rate of the man in the thirties at 12 o'clock on Friday is 3%, the frequency to the audiences is 1 and a proportion of the audiences is 3%, and then, the average frequency can be calculated as 0.03. The advertisement frequency estimation portion (102) can calculate the frequency of the CM for the car B by conducting the calculation processing on the basis of the advertisement information DB.

Regarding the meaning of the frequency, the following is known. That is, audiences do not fully recognize an advertisement if they have contact with the advertisement only once and an advertisement effect expected by the advertiser cannot be obtained. Herbert E. Krugman's Three-Hit Theory as a distinguished study is known, which says that the following reactions are found regarding repetition effect of an advertisement. First contact with advertisement→reaction as what it is, second contact with the advertisement→reaction as what is told about that, third contact with the advertisement→reaction to recall, fourth contact and after with the advertisement→repetition of the third reaction. That is, audiences are said to recognize the advertisement contents through at least three times of contact with the advertisement. However, since the number of three times is changed by various factors, that is a value which should be set appropriately depending on advertisement.

Particularly, it is known that the number of recognition times by contact with an advertisement is changed by the audiences, CM targeted products, types of campaign and the like, and a recognition times can be derived by means of calculation with a predetermined method based on a recognition times database defined separately in accordance with the audience, product, type of campaign and research results. In this device (10), such calculation processing can be executed. The effective contact with the advertisement as above can be confirmed by the frequency.

The higher frequency is not necessarily the better, and there can be a required minimum effective frequency (minimum effective frequency) for recognition and an effective frequency (maximum effective frequency) as an upper limit that will not tire the audience. These numbers of times can be defined in general such that the minimum effective frequency is 4 and the maximum effective frequency is 13, for example. Also, they might be determined manually on the basis of the research results on recognition rates and loss of interest in the CM conducted by a research company.

Calculations can be made on the basis of predetermined research results by various known calculation methods by the above minimum/maximum effective frequencies. The device (10) is provided with such a calculation processing function so that set values of effective frequencies can be changed for advertisement information of the processing target according to the audience, CM targeted product and the type of campaign.

In this embodiment, description is made using the relation between the frequency and the recognition number of times of advertisement, but various indexes for advertisement audiences can be used in addition to the recognition number of times. For example, the number of times till the contents (message) of the CM is understood or the number of times till an intension to purchase the product introduced in the CM is generated can be grasped in the relation with the frequency. These two indexes both have values larger than that of the recognition number of times but may be used in combination in the following transmission conditions such that all the plurality of indexes are satisfied or any of them is satisfied.

In the present invention, as the transmission conditions of the advertisement condition DB (122), conditions as in Table 3 can be added to the conditions in the first embodiment.

TABLE 3
Transmission conditions [frequency condition added]

| | | | | Transmission |
|---|---|---|---|---|
| 1 | Ad contents | Ad data | Ad frequency | position |
| 2 | Product A1 | Streaming | 0 to 4 | Popup window |
| | | data 1 | | |
| 3 | Product A1 | Banner data 1 | 5 to 13 | Banner ad |
| | | | | region 1 |
| 4 | Product A1 | None | 14 or more | (transmission |
| | | (transmission | | stopped) |
| | | stopped) | | |

According to Table 3, during time when recognition of the advertisement is important till the advertisement frequency reaches 4, the advertisement with the highest effectiveness is transmitted using a popup window, and with the frequency of 5 to 13 within the effective frequency, a banner advertisement is transmitted to the banner advertisement region 1. However, if the frequency exceeds 14, the advertisement contents have been already fully recognized by audiences, and further advertisement might have the opposite effect, and thus, the transmission is stopped.

The subsequent processing is similar to that of the first embodiment as shown in FIG. 4, in which the advertisement transmission portion (105) determines satisfaction of the transmission conditions (S21) and executes the advertisement transmission step (S22). By incorporating the frequency in the transmission condition, the advertisement effectiveness can be further improved.

### Third Embodiment

In addition to the advertisement frequency described in the second embodiment, a parameter called advertisement reach can be added to the transmission condition. As a third embodiment, a configuration in which the CPU (100) shown in FIG. 2 is provided with an advertisement reach estimation portion (103) and its estimation result is used for determination of the transmission condition will be described.

The advertisement reach will be described using FIG. 8. In advertising agencies, advertisement reach (reach) is used as a parameter for measuring advertisement effectiveness. A proportion of people in contact with the advertisement contents (creative) in the people of the entire public or a part thereof is the reach.

The reach can be also researched by various methods, and an average reach can be known by conducting a questionnaire such that “Have you ever seen the CM of the car B by the A company?” in an audience research. In the present invention, such research results may also be stored in the hard disk (120) and used as they are.

Here, a configuration in which the advertisement reach estimation portion (103) executes and processes an advertisement reach estimation step (S31) after the above-mentioned advertisement frequency estimation step (S30) according to a processing flowchart shown in FIG. 5 will be described. The order of the advertisement frequency estimation step (S30) and the advertisement reach estimation step (S31) is arbitrary or may be simultaneous. In the advertisement reach estimation step (S31), information on the number of broadcast times and broadcast time in the advertisement information DB (121) and information on the audience rate separately researched are used.

As shown in FIG. 8, supposing that an audience rate of a part of an audience of the public (a man in the thirties) is 0% at 10 o'clock on Friday, 1% at 11 o'clock, and 3% at 12 o'clock, and the number of CM transmission times of the car B by the A company is 0 times, 0 times, and 1 time, it means that the reach at 12 o'clock on Friday is 3%.

Also, by multiplying the audience rate for each time zone by the CM transmission number of times and integrating them, the total reach can be calculated. The total reach is an index frequently used as indication of reach and represented by GRP (Gross Rating Point). Referring to the portion shown in FIG. 8 (Equation 1), 0%×0 times+1%×0 times+3%×1 time+3%×0 times+4%×1 time+5%×2 times+5%×2 times+5%×2 times+6%×2 times=49 GRP.

The advertisement reach estimation portion (103) of the present invention executes processing for calculating the advertisement reach by the above calculation. Here, as an embodiment of the present invention, the transmission conditions may be defined on the basis only of the advertisement reach. For example, the advertisement is defined to be transmitted when the advertisement reach is 5% or more so that the banner advertisement is displayed when many people come into contact with the advertisement. Alternatively, by using the total reach, it may be defined such that the advertisement is transmitted when GRP exceeds 1800.

In this embodiment, from the frequency by the advertisement frequency estimation step (S30) and the reach by the advertisement reach estimation step (S31), the reach distribution per frequency can be also obtained.

### Fourth Embodiment

In the third embodiment, the configuration using the frequency and the reach in combination or the configuration using only the reach is described. According to the combination of the former, the reach distribution per frequency can be obtained, and a method using the distribution as a transmission condition will be described later. Prior to that, a method of obtaining the reach distribution per frequency only by an action of the advertisement reach estimation portion (103) will be described in detail.

In this embodiment, as shown in FIG. 6, first, the CM broadcasting number of times/broadcast time and data of the audience rate in that time are inputted in the advertisement reach estimation portion (103) so as to obtain the reach distribution per frequency (advertisement reach estimation step: S40). A specific calculation method will be described using FIG. 9. First, using a man as a sample, probability that the man views the CM in a time zone A and a time zone B is acquired. This information can be obtained since presence of viewing in each time zone and each channel is contained by the unit of individuals in the audience rate data (it is well known that such audience rate data is distributed).

For example, if a man views the CM at 10 o'clock (time zone A) on Monday in the first week and does not view it in the same time zone in the second week, its probability is 50%. Similarly, if the man views it at 11 o'clock (time zone B) once in five weeks, the audience rate is 20%. The audience rate, here, is described as a probability of actually viewing the CM, but the media contact rate (probability of contact with media) and the advertisement attention rate (probability to actually pay attention to the advertisement in the people who had contact with the media) might be distinguished in general, and the audience rate may be a media contact rate or a probability (advertisement reach) obtained by multiplying the media contact rate by the advertisement attention rate.

For simplification of the explanation, only two time zones for a specific channel of a single sample will be explained, here, but actually, they all become plural parameters and a large amount of calculation processing is required. A unit of a time zone with a certain channel is called a unit in general, and the time zone A is called a unit A and the time zone B as a unit B, here.

First, the reach per unit is calculated (Step S40-1, S40-2). At this time, supposing that the CM is broadcast twice in the time zone A (800) and three times in the time zone B (801), the number of times that the CM reaches the man and its probability at that time can be calculated according to a known probability distribution model. As the probability distribution model, binominal distribution, Poisson distribution, normal distribution and the like are often used.

For example, if probabilities are distributed according to the binominal distribution, they can be calculated as follows, respectively. A probability P(r) based on the binominal distribution is expressed by an equation 2.

P(r)=ₙCᵣp^{r}(1−p)^{n-r} (Equation 2)

Here, the audience rate in the unit A is 0.5, and the audience rate in the unit B is 0.2, and then, p=0.5 and p=0.2, respectively. Also, since the CM is broadcast twice in the unit A and three times in the unit B, they are n=2 and n=3, respectively.

Then, for the unit A,

0-times reach probability is ₂C₀×0.5⁰×(1−0.5)²=0.25;

1-time reach probability is ₂C₁×0.5¹×(1−0.5)¹=0.50; and

2-times reach probability is ₂C₂×0.5²×(1−0.5)⁰=0.25.

For the Unit B,

0-times reach probability is ₃C₀×0.2⁰×(1−0.2)³=0.512;

1-time reach probability is ₃C₁×0.2¹×(1−0.2)²=0.384;

2-times reach probability is ₃C₂×0.2²×(1−0.2)^{1=0.096}; an

3-times reach probability is ₃C₃×0.2³×(1−0.2)⁰=0.008.

Graphs illustrating the distribution of each frequency of each unit are graphs (802) (803) in FIG. 9. In order to combine the reach of each unit, by totaling the frequencies in each unit, the result is as shown in the following Table 4. The table indicates that if the reach is once in A and twice in B, the total is three times.

TABLE 4

B

| | Frequency | 0 | 1 | 2 | 3 |
|---|---|---|---|---|---|
| A | 0 | 0 | 1 | 2 | 3 |
| | 1 | 1 | 2 | 3 | 4 |
| | 2 | 2 | 3 | 4 | 5 |

If the distribution of the probabilities corresponding to Table 4 is acquired, the probability of 0 times in A is, for example, 0.25 from the above calculation and the probability of 0 times in B is 0.512, and then, 0.25×0.512=0.128. If all the calculations are carried out similarly, the distribution is as shown in Table 5.

TABLE 5

B

| | Frequency | 0 | 1 | 2 | 3 |
|---|---|---|---|---|---|
| A | 0 | 0.128 | 0.096 | 0.024 | 0.002 |
| | 1 | 0.256 | 0.192 | 0.048 | 0.004 |
| | 2 | 0.128 | 0.096 | 0.024 | 0.002 |

From the above table, the probability that the CM reaches the man 0 times is as.128, and the probability of reach once can be calculated as 0.096+0.256=0.352, which results in Table 6.

TABLE 6

| Advertisement frequency | Advertisement reach |
|---|---|
| 0 | 0.128 |
| 1 | 0.352 |
| 2 | 0.344 |
| 3 | 0.146 |
| 4 | 0.028 |
| 5 | 0.002 |

This is a step (S40-3) to obtain the advertisement reach distribution to a certain person by combining the reaches of plural units as above. Actually, by carrying out the above for a large number of sample people and taking an average value, the distributions of the advertisement frequency and advertisement reach in a certain period can be obtained.

For example, the β binominal distribution model by Metheringham can be used as a more sophisticated method. This model is widely used in order to obtain the frequency distribution and is known to be able to obtain accurate values with fewer parameters (See Non-Patent Document 2). Other than that, as the method for obtaining probability distribution in the present invention, known suitable techniques can be used as appropriate.

Non-Patent Document 2: Shigeru Kido, “Advertisement Management”, pp. 28 to 54, Asakura Shoten, May 15, 2004

A graph (804) of the distribution in Table 6 is shown in FIG. 9. Samples may be selected at random in order to express the entire public or the distribution of a part of the public such as female in the thirties or male college students, for example, may be obtained.

As mentioned above, from the methods in the third embodiment or in the fourth embodiment which can calculate accurate data more suitably or from direct research, the distributions of the frequency and reach can be obtained. A graph of the same kind as that of the graph (804) in FIG. 9 and closer to the actuality is shown in FIG. 10. A part of data in FIG. 10 is shown in Table 7.

TABLE 7

| Frequency X | X-times reach | X-times or more reach |
|---|---|---|
| 1 | 4.0% | 98.0% |
| 2 | 4.5% | 94.0% |
| 3 | 5.0% | 89.5% |

By calculating the reach x-times or more as in Table 7, indexes of advertisement effectiveness more precise than the advertisement frequency in the second embodiment can be obtained such that those who saw the advertisement once or more is 98% and twice or more is 94%, for example.

In the advertisement frequency in FIG. 10, if 4 times to 11 times (a painted portion in the graph) are effective advertisement frequencies, the target the advertisement reached is the target which the advertisement contents effectively reach. The total of the advertisement reach in this number of times region is called effective advertisement reach (effective reach).

In this embodiment, the effective advertisement reach is defined as the transmission condition as in Table 8.

TABLE 8
Transmission condition (effective advertisement
reach condition added)

| | | | Effective ad | Transmission |
|---|---|---|---|---|
| 1 | Ad contents | Ad data | reach | position |
| 2 | Product A1 | Streaming | 60% or more | Popup window |
| | | data 1 | | |
| 3 | Product A1 | Banner data 1 | 30 to 60% | Banner ad |
| | | | | region 1 |
| 4 | Product A1 | Text data 1 | 30% or less | Text ad |
| | | | | region 1 |

Similarly to the first and second embodiments, if the advertisement transmission portion (105) determines that the transmission condition is satisfied (S32) (S41), the advertisement data is transmitted at the advertisement transmission step (S33) (S42).

### Fifth Embodiment

Moreover, in the present invention, a terminal installed position information acquisition portion (106) may be provided in the CPU (100) of this device (10). The terminal installed position here refers to information regarding in which prefecture the user terminal device is installed, for example. As is well known, different programs and CMs are broadcast in TV and radio broadcast according to prefecture in many cases, and a broadcast station viewed by viewers can be estimated from a position of the user terminal device.

As for the user terminal device, an installed position can be acquired by an IP address and a domain name on the Internet, for example. That is, an information table as in Table 9 is provided in the hard disk (120) in advance so that the IP address or domain name of the user terminal device is acquired and checked at access from the terminal device. At this time, it can be estimated from a name of an access point of ADSL or the like.

TABLE 9

| IP address/domain name | Prefecture |
|---|---|
| 202.32.61.1 | Tokyo |
| tohoku.ac.jp | Miyagi |
| aichi.adsl.ntt.ne.jp | Aichi |

The information is acquired by the terminal installed position information acquisition portion (106), and the prefecture of the user terminal device as a transmission destination is included in the transmission condition. According to this configuration, by defining a condition that the user terminal device should be in any one of prefectures in the Kanto District in the transmission condition in Table 8, the advertisement data is not transmitted to user terminal devices other than the Kanto District. According to this configuration, since the advertisement data can be transmitted locally to an area in which the CM is broadcast, advertisement effectiveness is improved, which can contribute to optimal distribution of an advertising cost.

### Sixth Embodiment

The case in which the broadcast program is the advertisement is explained in the above embodiment, but the present invention can be intended for any broadcast show such as news, information program, variety program, quiz show, sport program and the like. First, the program contents are extracted from the database of the program contents such as an electronic program table. Then, suppose that the following broadcast information database is provided, for example.

TABLE 10
Broadcast information

| Broadcast | Broadcast | Broadcast | | |
|---|---|---|---|---|
| show | contents | station | Start time | End time |
| News A | Hybrid car on | X TV | 12/1 | 12/1 |
| | the rise | | 15:00:00 | 15:30:00 |

That is, in the news A, news with the contents that the number of hybrid car registrations is on the rise is broadcast, and the time is from 15:00 to 15:30 on December 1 is recorded.

After such news is broadcast, consumers' interest in the hybrid cars is heightened, and it is preferable to transmit the advertisement immediately after that. Therefore, by providing the following transmission condition, for example, the advertisement can be transmitted.

TABLE 11
Transmission condition

| Keyword | | | | |
|---|---|---|---|---|
| contained in | | | | |
| the broadcast | | Transmission | Transmission | Transmission |
| contents | Ad data | start timing | end timing | position |
| Hybrid car | Banner data | Simultaneously | 1 hour after | Banner ad |
| | 1 | with broadcast | the | region 1 |
| | | start | broadcast | |
| | | | end | |

According to the above transmission condition, the transmission condition is determined by detecting that the keyword of the “hybrid car” is included by a known character string search technique, morphological analysis technique and the like from the broadcast contents “hybrid car on the rise”, and the banner data 1 is transmitted to the banner advertisement region 1 simultaneously with the broadcast start.

### Seventh Embodiment

Moreover, even for the advertisements not included in the broadcast contents in the electronic program table, information on the goods relating to the goods and service can be extracted from the broadcast contents by providing an information extraction portion, not shown, in the CPU (100). That is, the information extraction portion refers to a goods information database, not shown, in the hard disk (120), determines that the information relates to a specific advertiser's goods from the broadcast contents, and can uses it as the advertisement contents of the above embodiment. For example, the following goods information database is provided.

TABLE 12
Goods information database

| Keyword contained in | |
|---|---|
| the broadcast contents | Advertisement contents |
| Car | Car A1 by A company |
| | Car inspection service B1 by B company |
| Metabolic | Salad oil C1 by C company |

If the “car” is contained in the broadcast contents, processing similar to the case in which advertisements of “car A1 by A company” and “car inspection service B1 by B company” are broadcast is executed. In this way, one broadcast may include two or more advertisement contents, or one for “metabolic” and one for “salad oil C1 by C company” may be defined, and setting can be made appropriately, giving consideration to advertisement effectiveness.

In the goods information database, the goods to be associated with the broadcast contents may be a name of a specific goods or a company name dealing with the goods. For example, instead of the salad oil C1 by the C company, it may be the mere business advertisement of the C company. Alternatively, it may be the advertisement of all the products handled by the C company.

As the broadcast program, the advertisement and the broadcast show may be both included in the configuration. That is, if the “car” is contained in the broadcast contents and the “car A1” is broadcast in the inserted CM, since the car is taken up in the program and also in the CM, viewers' interest has been increased, and transmission of the advertisement data of the car at this timing exerts synergetic effects.

The configuration of the present invention is as described above, and the device (10) is preferably incorporated in a server device of a search site in the Internet such as Yahoo! (registered trademark) or Google (registered trademark), for example. In general, many of viewers motivated to search the advertisement contents upon seeing the CM make an access to the search site. Thus, by transmitting the advertisement relating to the present invention in a banner column or the like on the search site, the advertisement can be presented to the users the most effectively.

Another merit in displaying the advertisement on the search site is that when the public who recognized the CM through mass media visits the search site, an advertisement such as a banner with associated advertisement contents is displayed and recognition or involvement with the CM or brand is increased for a longer period than the unit of minute or hour during which the CM is broadcast, that is, the unit of day, week or month. Advertisements are preferably transmitted to the public through a plurality of paths, and even viewers who do not see or recognize the CM increase the recognition of the product by the advertisement in a banner, and if the CM reaches the viewers in that state, larger advertisement effectiveness can be exerted.

Also, those who saw the CM in the banner can be surely led to the homepage of the target product. For advertisers, it is preferable that the viewers who saw the CM access their own web pages, and the banner advertisements in the search site have an important meaning.

Similarly, the device (10) can be incorporated in a server device of a goods sales site (Rakuten (registered trademark), for example) selling the goods. In this configuration, when the viewers saw the CM and started a purchasing activity, it is preferable that the viewers are directly led to the web page of the goods or a purchase page without competitors' goods which could be examined for purchase at the site or outflow to other goods, and transmission of the banner advertisements and the like has an extremely high effect from the viewpoint of advertisement effectiveness.

Other than the configuration to be incorporated in the search site server or goods sales site server, there can be a configuration in which image data or the like as the advertisement data is transmitted to regions such as predetermined banner advertisement columns, text advertisement columns and the like in each server in conjunction with these existing servers or a configuration in which the image data or the like stored in the device as a link from the regions is transmitted to a user terminal device.

### BRIEF DESCRIPTION OF THE DRAWINGS

FIG. 1 is an entire diagram of a system in which a network advertisement transmitting device according to the present invention is installed.

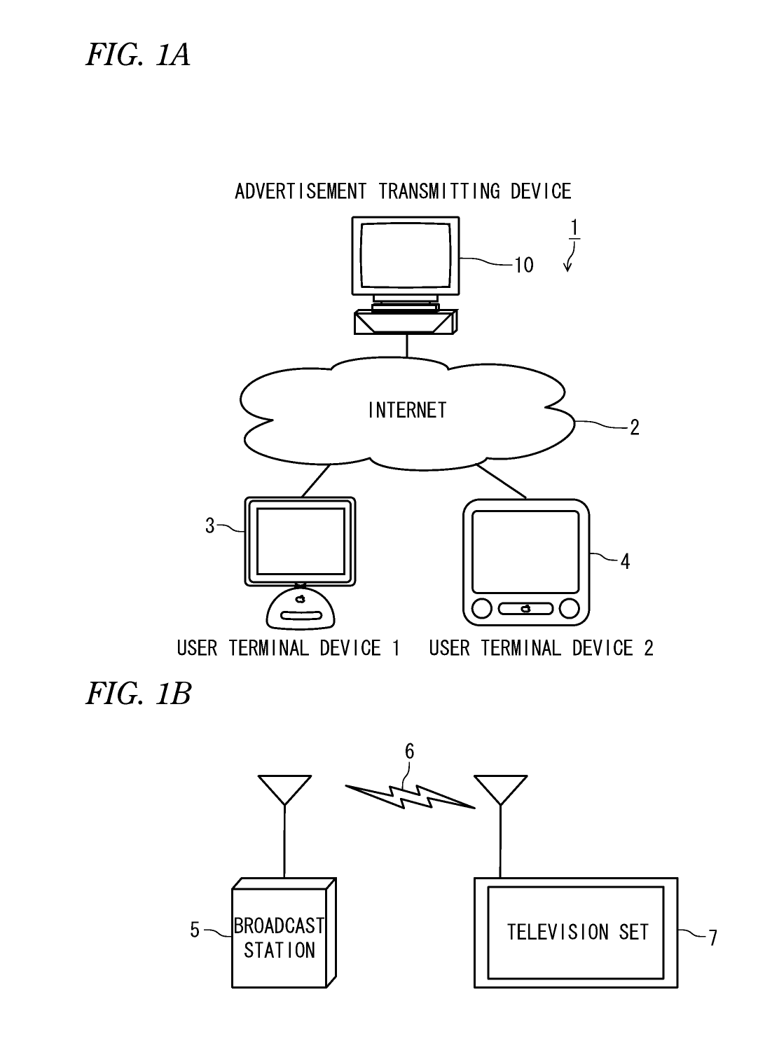

FIG. 2 is a configuration diagram of the network advertisement transmitting device according to the present invention.

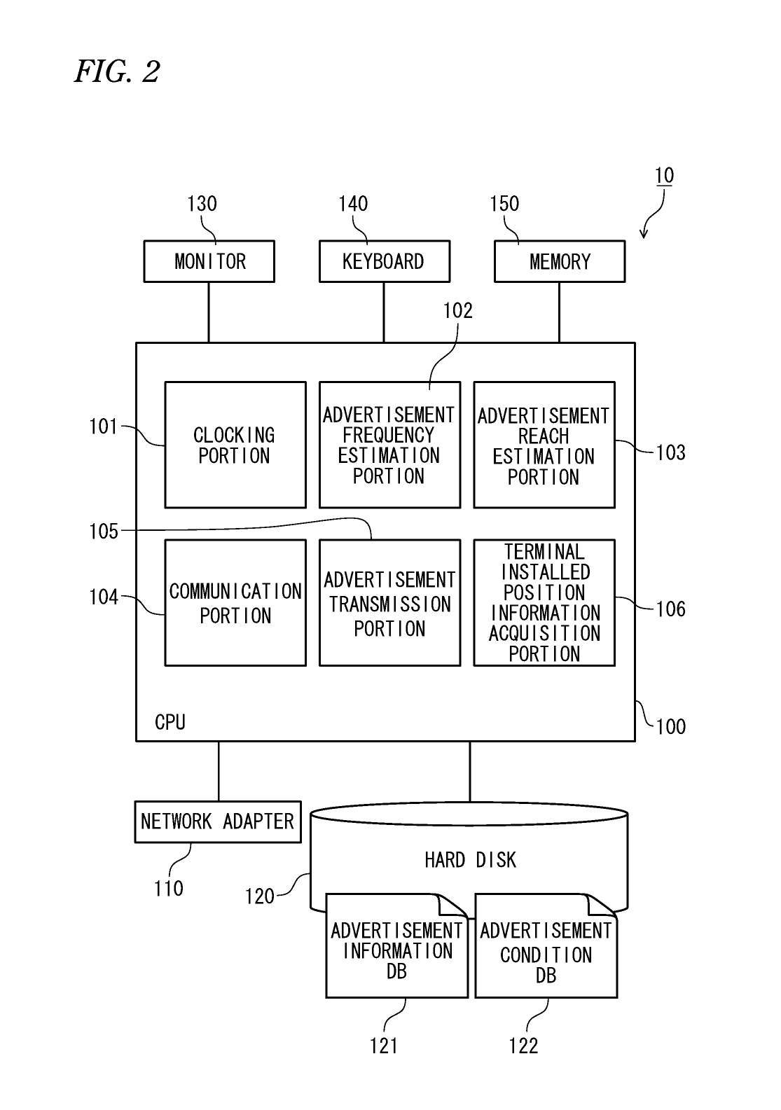

FIG. 3 is a processing flowchart (first embodiment) of a network advertisement transmitting method according to the present invention.

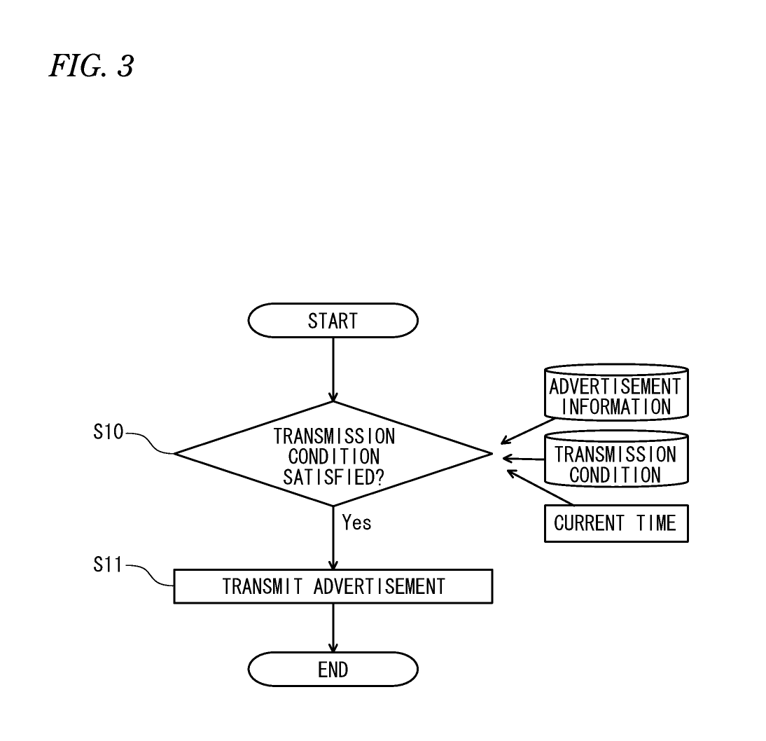

FIG. 4 is a processing flowchart (second embodiment) of a network advertisement transmitting method according to the present invention.

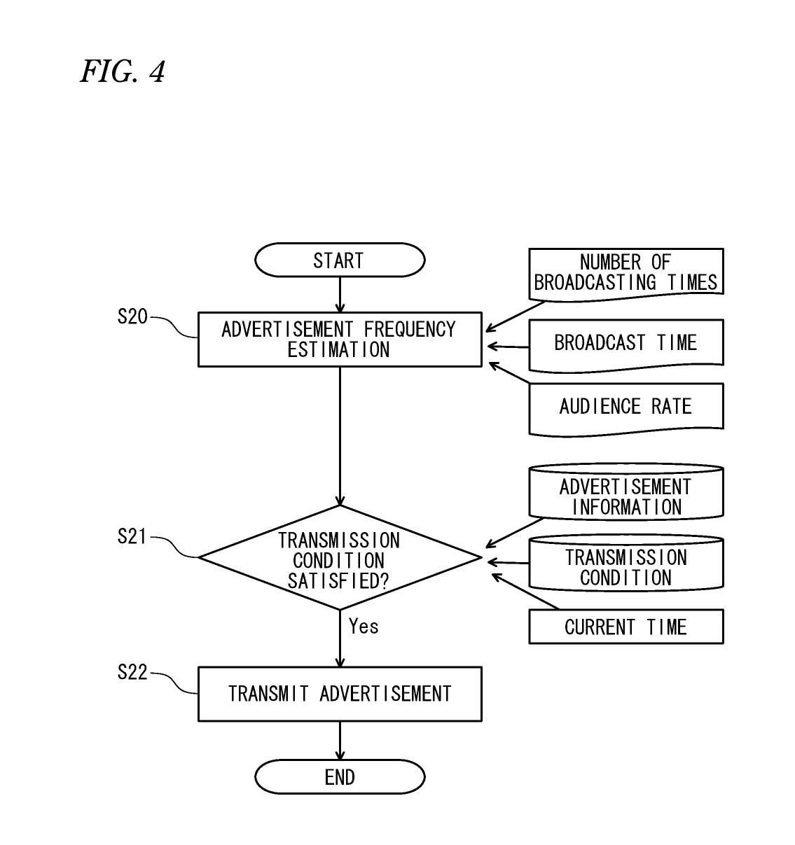

FIG. 5 is a processing flowchart (third embodiment) of a network advertisement transmitting method according to the present invention.

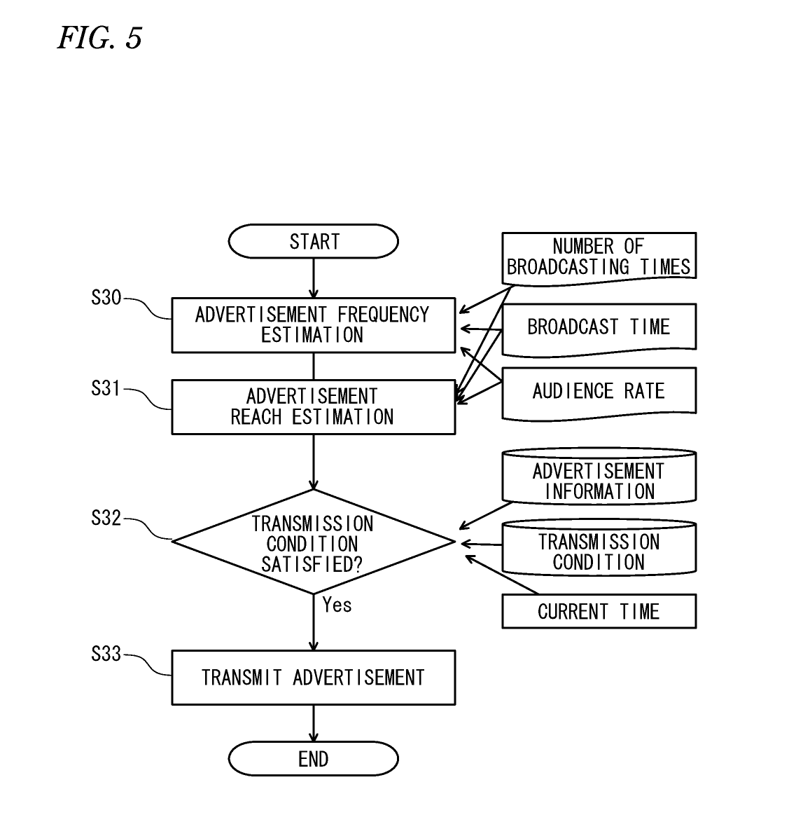

FIG. 6 is a processing flowchart (fourth embodiment) of a network advertisement transmitting method according to the present invention.

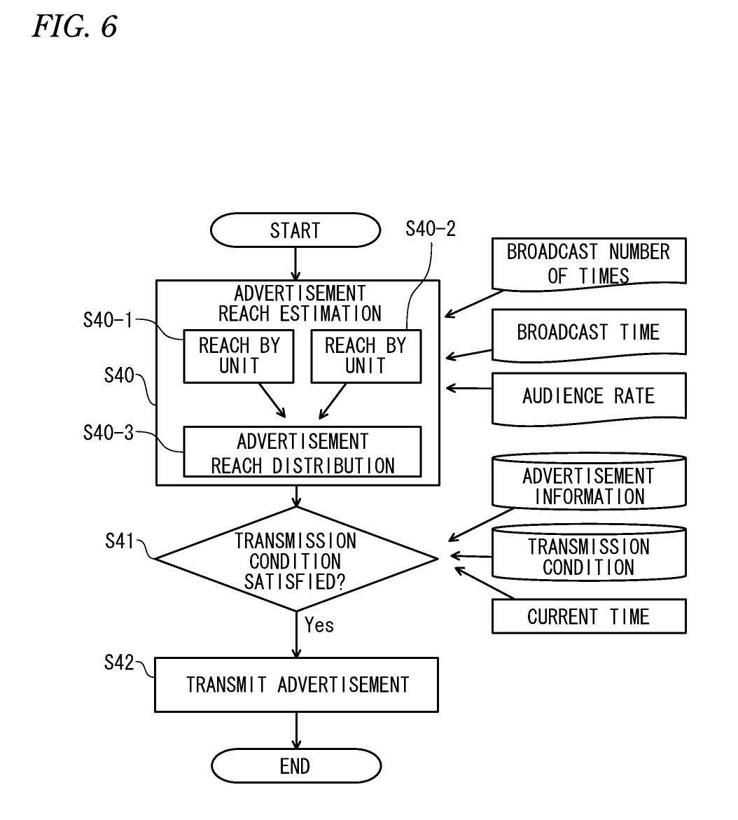

FIG. 7 is a diagram for explaining a calculation method in an advertisement frequency estimation portion.

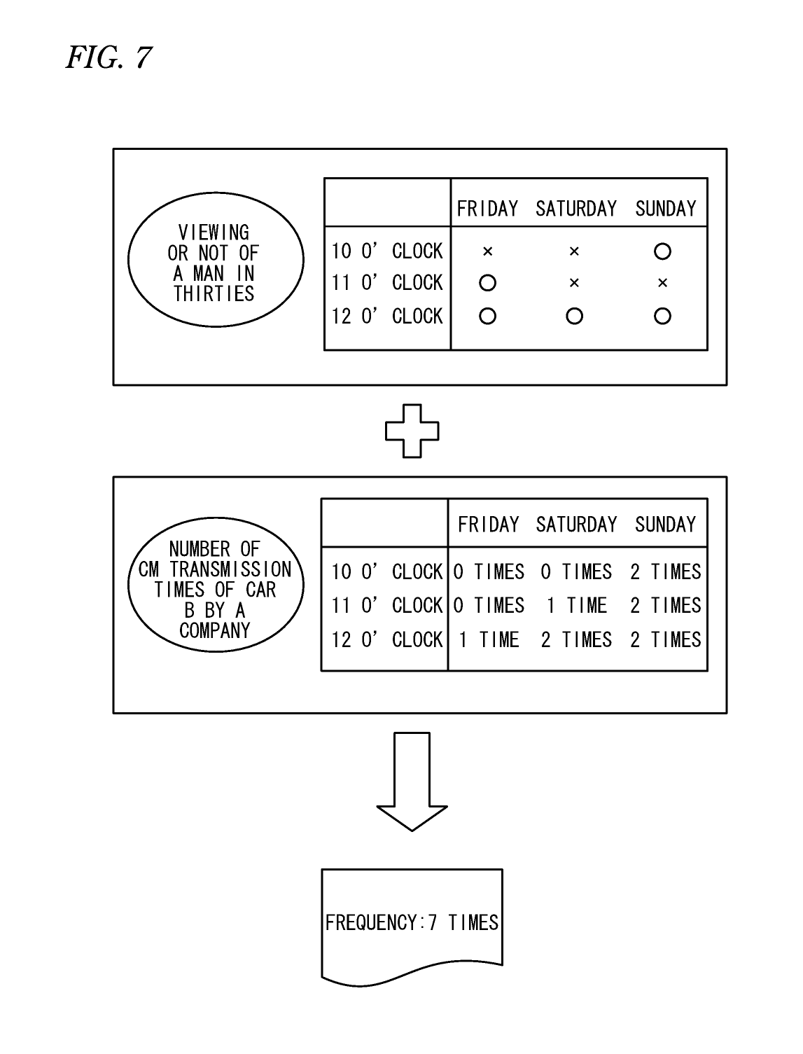

FIG. 8 is a diagram for explaining the calculation method (third embodiment) in the advertisement reach estimation portion.

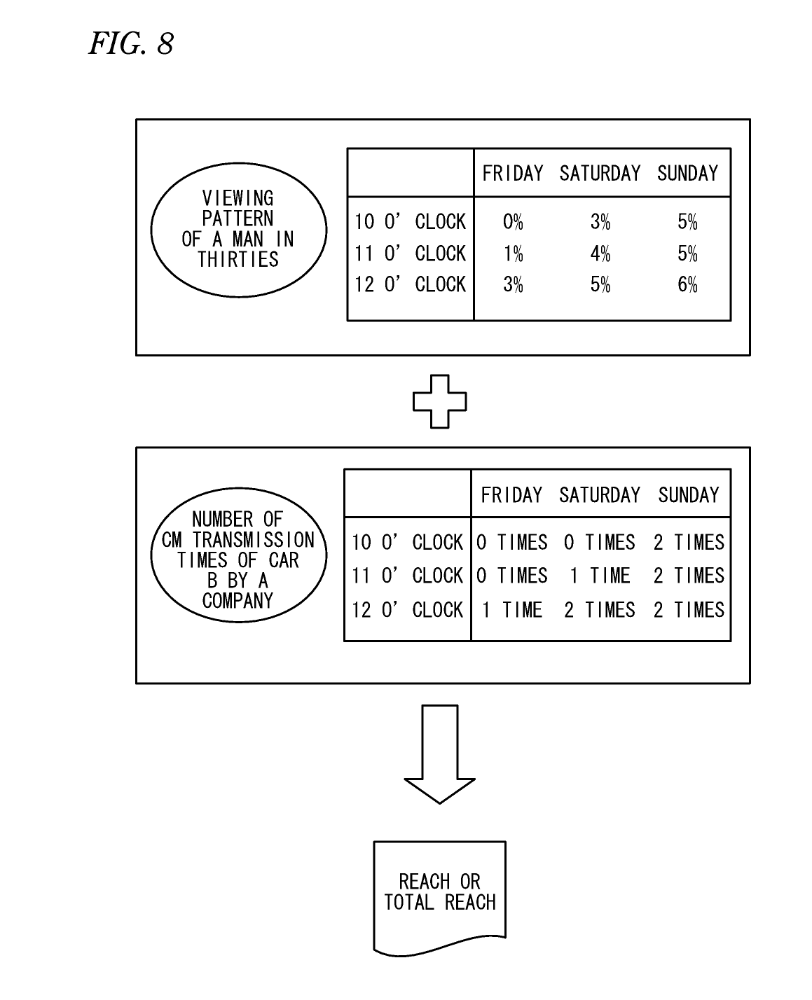

FIG. 9 is a diagram for explaining the calculation method (fourth embodiment) in the advertisement reach estimation portion.

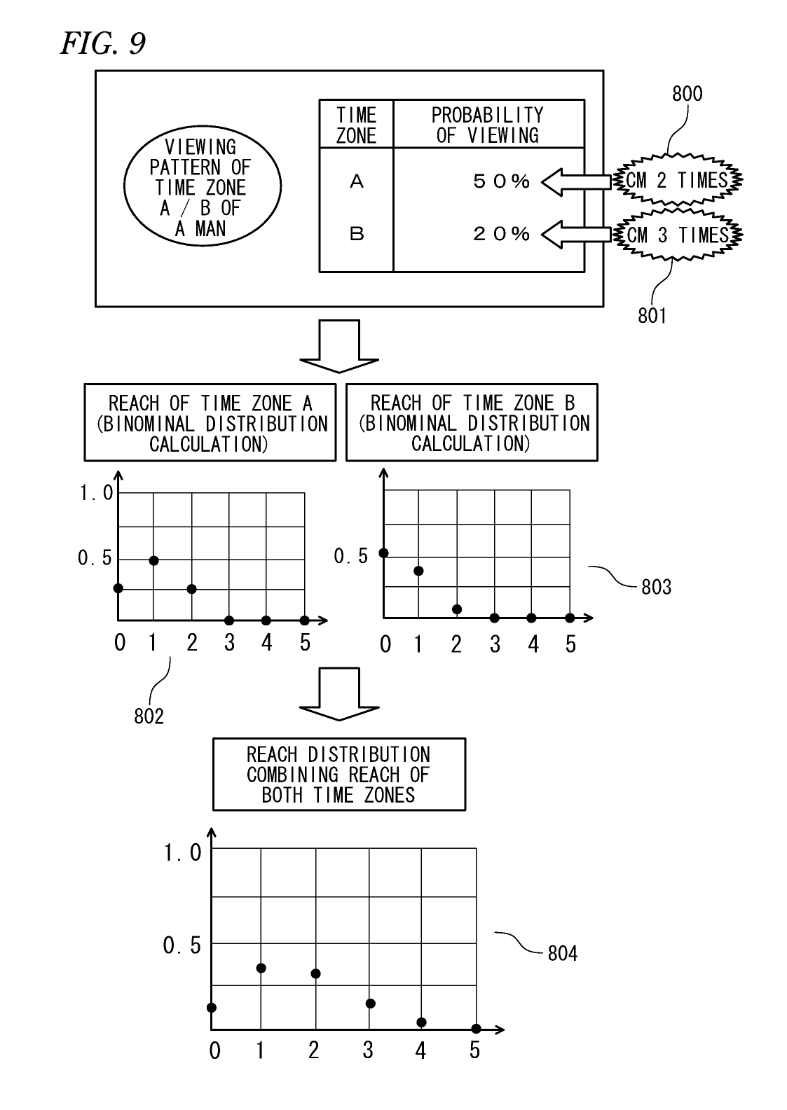

FIG. 10 is a graph illustrating effective advertisement frequency distribution.

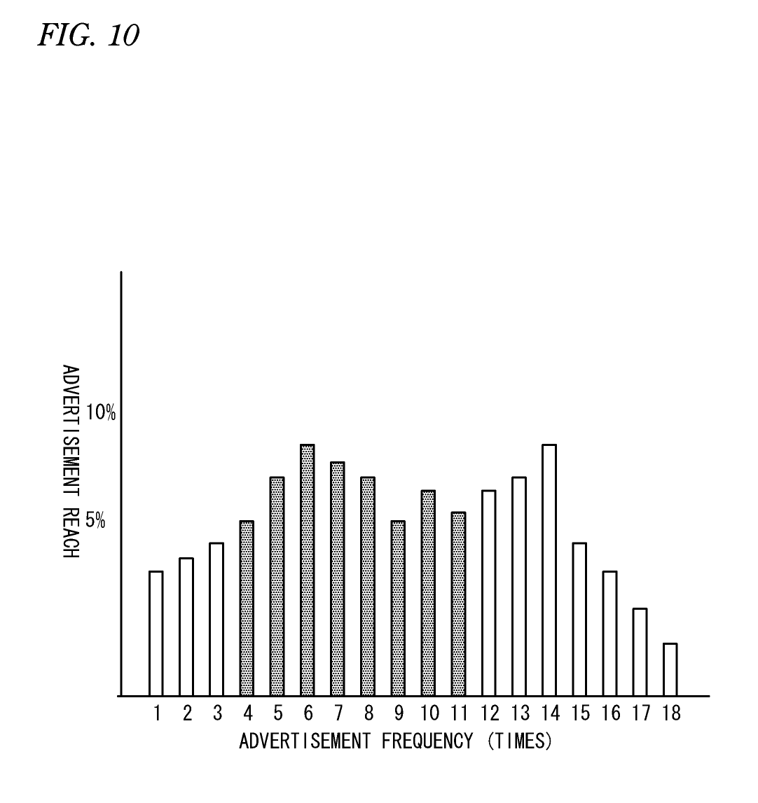

FIG. 11 is an image of a screen for explaining a position of an advertisement display.

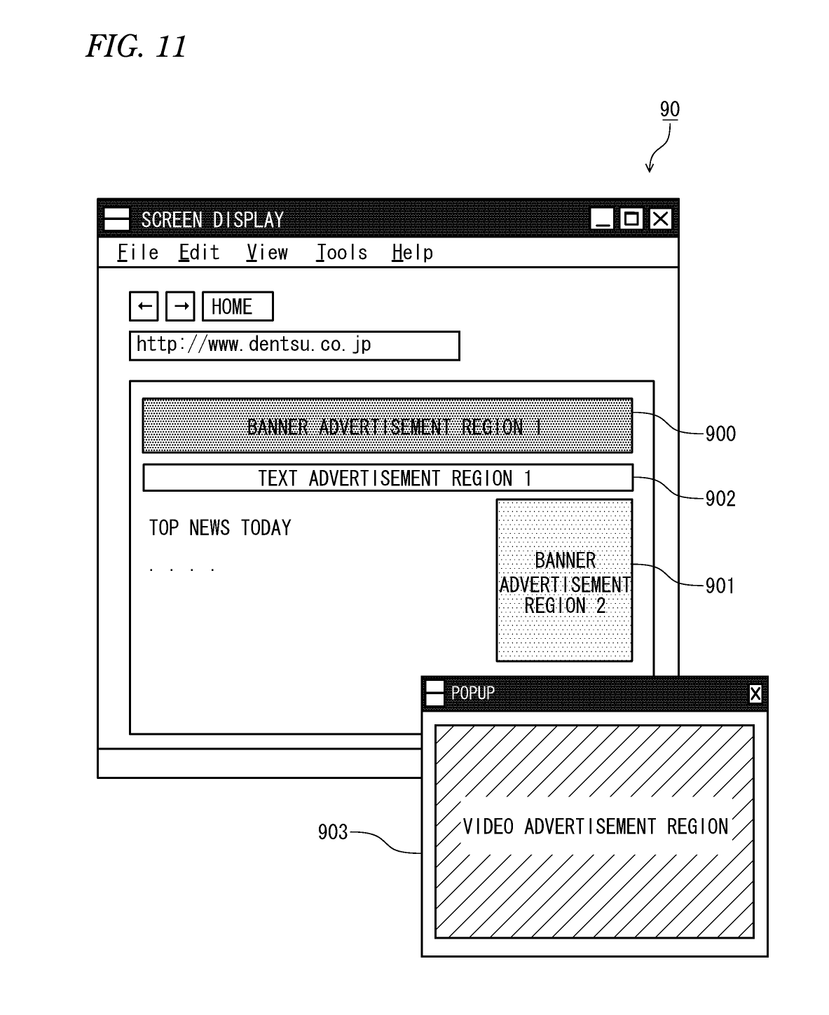

### EXPLANATION OF REFERENCE NUMERALS

10 network advertisement transmitting device
100 CPU
101 clocking portion
102 advertisement frequency estimation portion
103 advertisement reach estimation portion
104 communication portion
105 advertisement transmission portion
106 terminal installed position information acquisition portion
110 network adapter
120 hard disk
121 advertisement information database
122 advertisement condition database
130 monitor
140 keyboard
150 memory

1. A network advertisement transmitting device connected to a user terminal device through a network and capable of transmitting advertisement data outputted at the user terminal device, comprising:
a broadcast information database storing broadcast information in storage means relating to at least broadcast contents and broadcast time of broadcast program transmitted on a wired or wireless broadcast medium intended to be directly received by the public;
an advertisement condition database storing corresponding advertisement data and transmission conditions thereof in storage means according to the broadcast contents, the transmission conditions including at least a condition relationship between the advertisement information and a current time; and
advertisement transmitting means for transmitting the advertisement data from the broadcast condition database to the user terminal device through the network if the current time obtained from clocking means satisfies the transmission condition.

2. The network advertisement transmitting device according to claim 1, including cases in which the broadcast programs are broadcast shows of news, sports, performance, entertainment, discussion and the like.

3. The network advertisement transmitting device according to claim 2, further comprising goods information extracting means for extracting information on goods relating to goods or service from the program contents of the broadcast program if the broadcast program is a broadcast show not having as its main purpose the promotion or sale of goods or services, so that the extracted information is used as advertisement content, the broadcast information at that time as advertisement information, and the broadcast information database at that time as an advertisement information database.

4. The network advertisement transmitting device according to any one of claims 1 to 3, wherein a case in which the broadcast program is an advertisement is included, and in which case, the broadcast contents are advertisement contents, the broadcast information is advertisement information, and the broadcast information database is the advertisement information database.

5. The network advertisement transmitting device according to claim 3 or 4, further comprising:
advertisement frequency related value (hereinafter referred to as “advertisement frequency”) estimating means for estimating the frequency that the advertisement content reaches a part of or the whole of the public on the basis of information including at least any one of the broadcast number of times, broadcast time, and broadcast audience rate of the advertisement information; and
a transmission condition table defining a transmission mode of the advertisement data corresponding to the advertisement frequency for each type of advertisement content in the advertisement condition database, wherein
the advertisement transmitting means transmits the advertisement data according to the advertisement frequency given by the advertisement frequency estimating means according to the transmission conditions.

6. The network advertisement transmitting device according to any one of claims 3 to 5, further comprising:
advertisement reach related value (hereinafter referred to as “advertisement reach”) estimating means for estimating advertisement reach that the advertisement information reaches a part of or the whole of the public on the basis of the information including at least any one of the broadcast number of times, broadcast time, and broadcast audience rate of the advertisement information; and
a transmission condition table defining a transmission mode of the advertisement data corresponding to the advertisement reach for each type of advertisement content in the advertisement condition database, wherein
the advertisement transmitting means transmits the advertisement data according to the advertisement reach given by the advertisement reach estimating means according to the transmission conditions.

7. The network advertisement transmitting device according to any one of claims 3 to 6, further comprising
terminal installation position information acquisition means for acquiring installation position information of the user terminal, wherein
the transmission conditions include a condition catering to the installed position of the user terminal.

8. The network advertisement transmitting device according to any one of claims 1 to 7, wherein the broadcast media is TV broadcast or radio broadcast.

9. The network advertisement transmitting device according to any one of claims 1 to 7, wherein the broadcast media is at least either one of image or video delivery or sound delivery using a network communication path.

10. The network advertisement transmitting device according to any one of claims 1 to 9, wherein the advertisement data is at least any one of text data, image data, video data or sound data constituting video advertisement, banner advertisement or text advertisement.

11. The network advertisement transmitting device according to any one of claims 1 to 10, wherein the network is the Internet.

12. The network advertisement transmitting device according to any one of claims 1 to 10, wherein the network is a cellular phone line or PHS phone line and the user terminal device is a phone terminal thereof.

13. The network advertisement transmitting device according to any one of claims 1 to 12, wherein
the network advertisement transmitting device is a search site server provided with a search engine of the Internet; and
the advertisement data is presented on the search site screen.

14. The network advertisement transmitting device according to any one of claims 1 to 12, wherein
the network advertisement transmitting device is a goods-sales site server selling goods on the Internet; and
the advertisement data is presented on the goods-sales site screen.

15. A network advertisement transmitting method of a computer in a network advertisement transmitting device connected to a user terminal device through a network and capable of transmitting advertisement data outputted at the user terminal device, comprising:
a broadcast information database storing broadcast information in storage means relating to at least broadcast content and broadcast time of broadcast programs sent on a wired or wireless broadcast medium intended to be directly received by the public;
an advertisement condition database storing corresponding advertisement data and its transmission conditions in the storage means according to the broadcast content in advance, the transmission conditions including at least a condition relationship between the broadcast information and the current time; and
an advertisement transmission step in which advertisement transmitting means of a computer transmits the advertisement data from the advertisement condition database to the user terminal device through the network if the current time obtained from the clocking means satisfies the transmission conditions.

16. The network advertisement transmitting method according to claim 15, including cases in which the broadcast programs are broadcast shows of news, sports, performance, entertainment, discussion and the like.

17. The network advertisement transmitting method according to claim 16, wherein
if the broadcast program is a broadcast show not having as its main purpose the promotion or sale of goods and services, a goods information extracting step is provided in which goods information extracting means of a computer extracts information on goods relating to an article or service from the program contents of the broadcast show prior to the advertisement transmission step; and
the extracted information is used as advertisement content, the broadcast information at that time as advertisement information, and the broadcast information database at that time as an advertisement information database.

18. The network advertisement transmitting method according to any one of claims 15 to 17, wherein
a case in which the broadcast program is an advertisement is included, and in that case, the broadcast contents are advertisement contents, the broadcast information is advertisement information, and the broadcast information database is the advertisement information database.

19. The network advertisement transmitting method of a computer according to claim 17 or 18, wherein
a transmission condition table defining transmission modes of the advertisement data corresponding to an advertisement frequency for each type of advertisement content is provided in advance in the advertisement condition database;
an advertisement frequency estimating step in which the advertisement frequency estimating means of a computer estimates the advertisement frequency at which the advertisement information reaches a part of or the whole of the public on the basis of information including at least any one of the broadcast number of times, broadcast time, and broadcast audience rate of the advertisement information is provided before the advertisement transmission step; and
in the advertisement transmission step, the advertisement transmitting means of a computer transmits the advertisement data according to the advertisement frequency given by the advertisement frequency estimating means according to the transmission conditions in the advertisement transmission step.

20. The network advertisement transmitting method of a computer according to any one of claims 17 to 19, wherein
a transmission condition table defining transmission modes of the advertisement data corresponding to an advertisement reach for each type of the advertisement contents is provided in advance in the advertisement condition database;
an advertisement reach estimating step in which the advertisement reach estimating means of a computer estimates the advertisement reach with which the advertisement information reaches a part of or the whole of the public on the basis of information including at least any one of the broadcast number of times, broadcast time, and broadcast audience rate of the advertisement information is provided before the advertisement transmission step; and
in the advertisement transmission step, the advertisement transmitting means of a computer transmits the advertisement data according to the advertisement reach given by the advertisement reach estimating means according to the transmission conditions.

21. The network advertisement transmitting method according to any one of claims 17 to 20, wherein
a terminal installation position information acquisition means of a computer is provided with a terminal installation position information acquisition step for acquiring installation position information of the user terminal before the advertisement transmission step; and
the transmission conditions include a condition catering to the installed position of the user terminal.

22. The network advertisement transmitting method according to any one of claims 15 to 21, wherein the broadcast media is a TV broadcast or radio broadcast.

23. The network advertisement transmitting method according to any one of claims 15 to 21, wherein the broadcast media is at least either one of image or video delivery or sound delivery using a network communication path.

24. The network advertisement transmitting method according to any one of claims 15 to 23, wherein the advertisement data is at least any one of text data, image data, video data or sound data constituting video advertisement, banner advertisement or text advertisement.

25. The network advertisement transmitting method according to any one of claims 15 to 24, wherein the network is the Internet.

26. The network advertisement transmitting method according to any one of claims 15 to 24, wherein the network is a cellular phone line or PHS phone line and the user terminal device is a phone terminal thereof.

27. The network advertisement transmitting method according to any one of claims 15 to 26, wherein
the network advertisement transmitting device for executing the network advertisement transmission method is a search site server provided with a search engine of the Internet; and
the image/video advertisement data is presented on the search site screen.

28. The network advertisement transmitting method according to any one of claims 15 to 26, wherein
the network advertisement transmitting device for executing the network advertisement transmission method is a goods-sales site server selling goods on the Internet; and
the advertisement data is presented on the goods-sales site screen.
